(19) United States
(12) Patent Application Publication
(10) Pub. No.: US 2014/0292495 A1
(43) Pub. Date: Oct. 2, 2014

(54) PROVIDING ENERGY TO A PASSIVE WIRELESS TAG

(71) Applicant: National Oilwell Varco, L.P., Houston, TX (US)

(72) Inventor: Ted Louis Christiansen, Houston, TX (US)

(73) Assignee: NATIONAL oILWELL VARCO, L.P., Houston, TX (US)

(21) Appl. No.: 14/355,510

(22) PCT Filed: Oct. 25, 2012
(86) PCT No.: PCT/US2012/061920

§ 371 Date: Apr. 30, 2014

Related U.S. Application Data
(60) Provisional application No. 61/553,718, filed on Oct. 31, 2011.

(51) Int. Cl. G06K 7/10

(52) U.S. Cl. CPC G06K 7/10158
USPC 340/10.34

(57) ABSTRACT

A system and method for communicating with a passive wireless tag. In one embodiment, a device for powering a passive wireless tag includes a power source, a first antenna, and a controller. The controller is configured to detect a wireless signal transmission directed to the passive wireless tag. The controller is further configured to transmit power extracted from the power source, via the first antenna, to the passive wireless tag, responsive to detection of the wireless signal transmission. The transmitted power is to be used to power the passive wireless tag.

### BACKGROUND

Wireless identification devices (i.e., tags), such as radio-frequency identification (RFID) tags and similar devices may be attached to, or incorporated into, an object to enable relatively easy and quick wireless identification of the object. Most wireless tags include circuitry for storing and processing information related to the object to which the tag is attached, and an antenna for receiving and transmitting a signal carrying such information. The information transmitted by the wireless tag is acquired by a tag querying system that may be portable or assigned to fixed location. To communicate, wireless tags respond to queries from the querying system by generating response signals received by the querying system. The response signals contain information about the object to which the wireless tag is attached.

Various classes of wireless tags are available. Passive tags include no internal power source, and derive power from wireless transmissions detected by the device. Active tags include a power source, such as a battery. Because of the relatively small amount of power available to passive tags, the signal transmission range of a passive tag may be substantially shorter than that of an active tag.

### SUMMARY

A system and method for communicating with a passive wireless tag. In one embodiment, a device for powering a passive wireless tag includes a power source, a first antenna, and a controller. The controller is configured to detect a wireless signal transmission directed to the passive wireless tag. The controller is further configured to transmit power extracted from the power source, via the first antenna, to the passive wireless tag, responsive to detection of the wireless signal transmission. The transmitted power is to be used to power the passive wireless tag.

In another embodiment, a method for extending the communication range of a passive wireless tag includes affixing a tag converter to a tool housing the passive tag. The tag converter detects a wireless transmission directed to the passive wireless tag. Responsive to the detecting, the tag converter provides power to the passive wireless tag by wireless transmission of a power signal.

In a further embodiment, a system for communicating with a downhole asset includes a wireless transceiver and a passive-to-active tag converter. The wireless transceiver is disposed at a fixed location. The passive-to-active tag converter is configured to removably attach to the downhole asset and detect wireless transmissions from the transceiver. The passive-to-active tag converter is also configured to wirelessly provide power to a passive wireless tag of the downhole asset responsive to detection of the wireless transmissions.

### BRIEF DESCRIPTION OF THE DRAWINGS

For a detailed description of exemplary embodiments of the invention, reference will now be made to the accompanying drawings in which:

FIG. 1 shows a block diagram of a system for communicating with a passive wireless tag in accordance with various embodiments;

FIGS. 2A, 2B, and 2C show views of a passive-to-active tag converter affixed to a downhole asset including a passive wireless tag in accordance with various embodiments;

FIG. 3 shows a block diagram of a passive-to-active tag converter in accordance with various embodiments; and

FIG. 4 shows a flow diagram for a method for communicating with a downhole asset including a passive wireless tag in accordance with various embodiments.

### NOTATION AND NOMENCLATURE

Certain terms are used throughout the following description and claims to refer to particular system components. As one skilled in the art will appreciate, companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. The embodiments disclosed are not to be interpreted, or otherwise used, as limiting the scope of the disclosure, including the claims. In addition, one skilled in the art will understand that the following description has broad application, and the discussion of any embodiment is meant only to be exemplary of that embodiment, and not intended to mean or suggest that the scope of the disclosure, including the claims, is limited to that embodiment.

In oil and gas industry applications, the environmental conditions experienced by downhole assets, such as downhole tools and the like, tend to be relatively harsh. For instance, a downhole asset may be commonly exposed to extreme temperature and pressure, corrosive and abrasive fluids, moisture, vibrations and impact loads. Consequently, a wireless tag attached to the downhole asset is also subject extreme environmental conditions.

Power sources, such as batteries, may be subject to accelerated degradation and/or damage when exposed to the harsh environment in which downhole assets are operated. For this reason, passive, rather than active, wireless tags are sometimes used with downhole assets. Unfortunately, the short communication range of conventional passive wireless tags may limit their usefulness and/or requires use of an interrogating device in close proximity to the downhole tool. For example, in some cases, an interrogating device must be positioned within a few inches (e.g., ten inches) of the passive wireless tag to enable communication. In contrast, an active wireless tag may allow communication at a range of 25 feet or more.

Embodiments of the present disclosure extend the range of a passive wireless tag affixed to a downhole asset, thereby providing the passive wireless tag with a communication range comparable to that of an active wireless tag. Embodiments of the active-to-passive tag converter disclosed herein are removably attachable to a downhole asset, and wirelessly transmit power to the passive wireless tag when the converter detects a tag querying device attempting to communicate with the passive wireless tag. Thus, the tag converter increases the power available to the passive wireless tag, and correspondingly increases the communication range of the passive wireless tag.

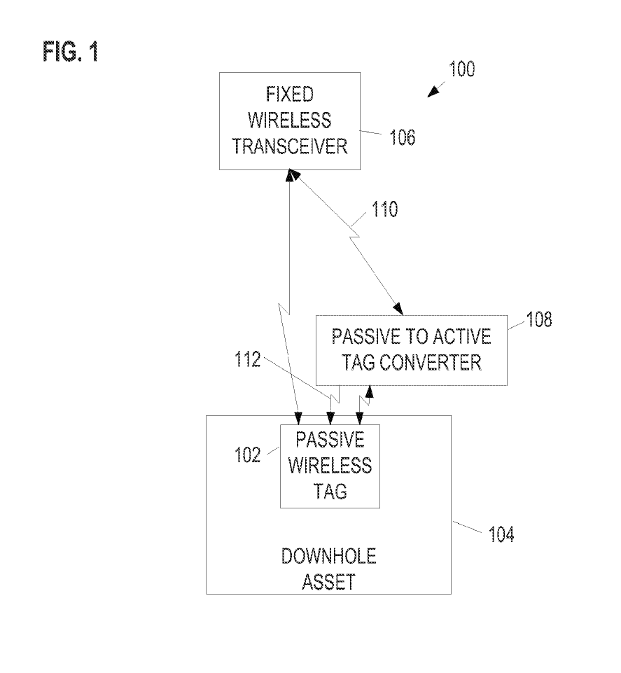

FIG. 1 shows a block diagram of a system 100 for communicating with a passive wireless tag 102 affixed to a downhole asset 104 in accordance with various embodiments. The system includes a fixed wireless transceiver 106, the downhole asset 104 including the attached passive wireless tag 102, and a passive-to-active tag converter 108. The fixed wireless transceiver 106 may be stationary and positioned at a site or facility where downhole assets are stored, repaired, prepared for field operations, etc. The fixed wireless transceiver 106 includes an antenna, transmitter, receiver, and other components for wirelessly communicating with the passive tag 102. The fixed wireless transceiver 106 may communicate with the passive tag 102 and retrieve information identifying the downhole asset 104 from the passive tag 102. The fixed wireless transceiver 106 may provide the information identifying the downhole asset 104 to an asset management system, an asset database, or the like.

The downhole asset 104 may be a drill pipe, a drill collar, a well casing, a wireline tool, a drill bit, or any other component for use downhole. The passive wireless tag 102 affixed to the downhole asset 104 may be configured to communicate using long wavelength magnetic signals in accordance with the IEEE 1902.1 standard. Some embodiments of the passive wireless tag 102 may be configured to operate in accordance with a radio frequency identification (RFID) standard or another wireless communication standard known in the art.

The passive wireless tag 102 includes circuitry, such as antennas, a power signal receiver, and a communication signal transceiver, information storage and processing circuitry, etc. The passive wireless tag 102 has a relatively short communication range, and may be unable to communicate with the fixed wireless transceiver 106 unless the distance between the passive wireless tag 102 and the fixed wireless transceiver 106 is no more than a few inches. Embodiments of the system 100 include the passive-to-active tag converter 108 to overcome the range limitation of the passive wireless tag 102. The passive-to-active tag converter 108 is positioned proximate to the passive wireless tag 102. For example, the passive-to-active tag converter 108 may be attached to the downhole asset 104 when the downhole asset is located at the site including the fixed wireless transceiver 106.

The passive-to-active tag converter 108 detects wireless transmissions 110 from the fixed wireless transceiver 106 and responsive to the detected signals, initiates wireless transmission of power signals 112 to the passive wireless tag 102. The passive wireless tag 102 detects and derives sufficient power from the power signals 112 to increase the transmission range of the passive wireless tag 102 to a range comparable to that of an active wireless tag (e.g., 25 feet). Thus, the passive-to-active tag converter 108 allows the passive wireless tag 102 to operate as an active tag with all the attendant advantages while tag communication is required, and avoids the disadvantages accompanying inclusion of a battery in the tag.

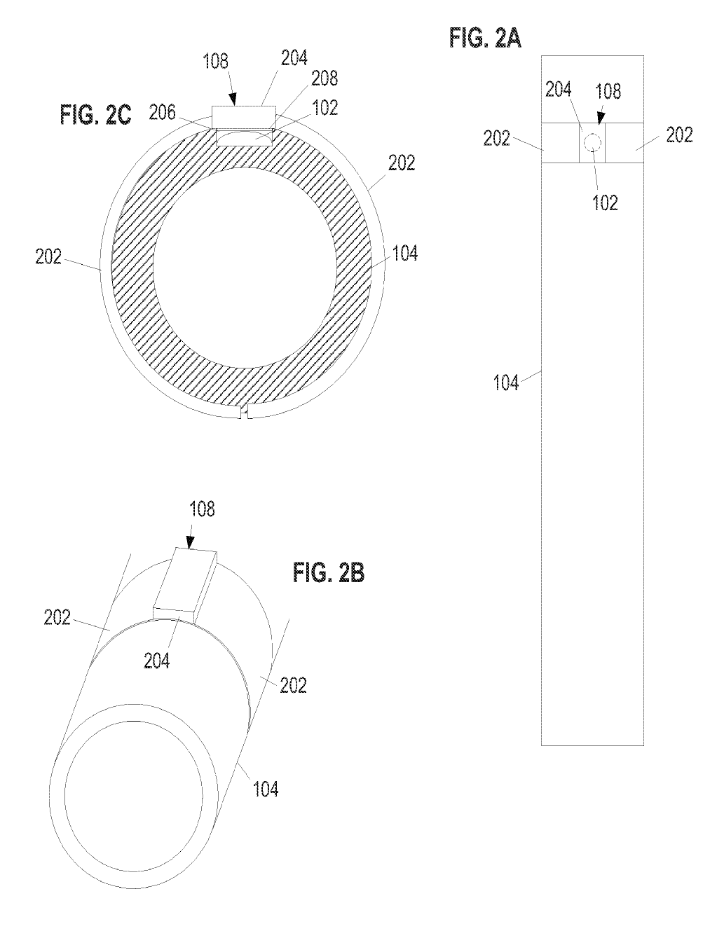

FIGS. 2A, 2B, and 2C show views of a passive-to-active tag converter 108 affixed to the downhole asset 104 including the passive wireless tag 102 in accordance with various embodiments. The downhole asset 104 is depicted as generally tubular, though in other embodiments, the downhole asset 104 may have different shape. FIGS. 2A, 2B, and 2C respectively show a top view, a perspective view, and a cross-sectional view of the downhole asset 104, and the passive-to-active converter 108 affixed thereto. The passive wireless tag 102 is disposed in a recess 206 in the exterior surface of the downhole asset 104. In other embodiments, the passive wireless tag 102 may be positioned at a different location on the downhole asset 104 (e.g., on the external surface or within the central bore of the downhole asset 104).

In the embodiment shown in FIGS. 2A-2C, the passive-to-active converter 108 is affixed to the outer surface of the downhole asset 104. The passive-to-active converter 108 includes one or more retention members 202 and a communication module 204. The retention members 202 removably attach the passive-to-active converter 108 to the downhole asset 204. In some embodiments of the passive-to-active converter 108, the retention members 202 include a bistable structure that in one position assumes a cylindrical shape. A bistable structure is a mechanical structure having two stable states or shapes. For example, a retention member 202 may have a first state where the retention member 202 is longitudinally flat when the converter 108 is not in use, and a second where the retention member is cylindrically coiled as shown in FIG. 2C. The cylindrical shape wraps about the outer surface of the downhole asset 104 to retain the passive-to-active converter 108 on the downhole asset 104. In other embodiments, the retention members 202 include a different attachment mechanism such as magnets, straps, adhesives, etc.

The communication module 204 includes an enclosure that houses the electronic circuitry of the passive-to-active converter 108. The enclosure may be formed of metal, plastic, epoxy, etc. The retention members 202 are attached to the communication module 204. The communication module 204 may also include an alignment feature arranged to position the communication module 204 at a location that optimizes wireless signal transfer between the passive-to-active converter 108 and the wireless passive tag 102. For example, the enclosure of the communication module 204 may include a protrusion 208 that fits into the recess 206, thereby aligning the communications module 204 with the passive wireless tag 102.

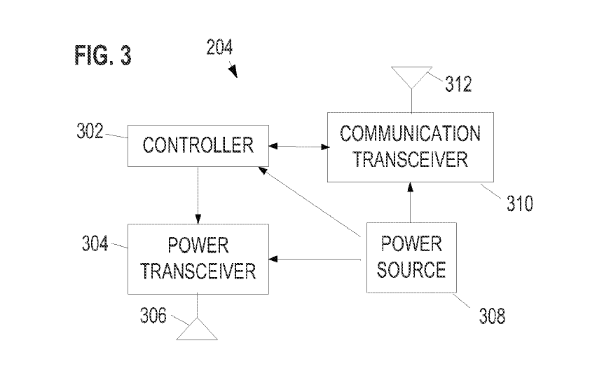

FIG. 3 shows a block diagram of the electronic circuitry of the passive-to-active tag converter communications module 204 in accordance with various embodiments. The electronic circuitry includes a controller 302, a power transceiver 304, a power antenna 306, a power source 308, a communication transceiver 310, and a communication antenna 312. The power source 308 provides power to operate the passive-to-active tag converter 108, and provides the power that is wirelessly transmitted to the passive wireless tag 102. The power source 308 may be a battery, such as a lithium ion battery or a nickel metal hydride battery, a photo-electric cell, or any other device suitable for powering the passive-to-active tag converter 108 and the passive wireless tag 102.

The power transceiver 304 is coupled to the power antenna 306, and includes a transmitter that transmits power signals for use by the passive wireless tag 102 via the antenna 306. The transmitter may be an inductive transmitter that transmits power via magnetic waves in the range of a few hundred kilo-hertz or less. The power transceiver 304 may include modulation and signal generation circuitry suitable for generation of the magnetic signals. The antenna 306 is tuned to couple the power signals generated by the power transceiver 304 to the wireless medium.

The communication transceiver 310 is coupled to the communication antenna 312, and includes circuitry to receive wireless signals transmitted by the fixed wireless transceiver 106 for communication with the passive wireless tag 102. The communication signals transmitted by the fixed wireless transceiver 106 and received by the communication transceiver 310 may be magnetic signals in the range of a few hundred kilo-hertz or less, and may be in a different frequency range than the power signals generated by the power transceiver 304. The antenna 312 is tuned to the wavelength of the communication signals. The communication transceiver 310 may also receive wireless signals transmitted by the passive wireless tag 102, and generate wireless signals for transmission to the passive wireless tag 102 and/or the fixed wireless transceiver 106. Such signals may be in the same frequency range as the signals generated by the fixed wireless transceiver 106. The communication transceiver 310 may include circuitry, such as a modulator, demodulator, encoder, decoder, signal generator, amplifier, filter, digitizer, etc., suitable for use in transmitting and/or receiving the magnetic communication signals. In some embodiments, the communication transceiver may be configured for operation in accordance with the IEEE 1902.1 standard.

The controller 302 manages the operations of the passive-to-active tag converter 108, and is coupled to the power transceiver 304 and the communication transceiver 310. The controller 302 activates the power transceiver 304 to generate the power signals that power the passive wireless transceiver 102. The controller 302 may also periodically activate the communication transceiver 310 to scan for and receive communication signals transmitted by the fixed wireless transceiver 106. The controller 302 activates the power transceiver 304 in response to reception by the communication transceiver 310 of wireless transmissions emanating from the fixed wireless transceiver 106. The controller 302 can also parse packets transmitted by the passive wireless tag 102 and received by the communication transceiver 310. The controller 302 can thereafter retransmit the information extracted from the packets to the fixed wireless transceiver 106 via the communication transceiver 310. Thus, the passive-to-active tag converter 108 can operate as a repeater of transmissions by the passive wireless tag 102.

Various components of the passive-to-active tag converter 102 including at least some portions of the controller 302 and the transceivers 304, 310 can be implemented using a processor included in the passive-to-active tag converter 102. The processor executes software programming that causes the processor to perform the operations described herein. In some embodiments, the controller 302 includes a processor executing software programming that causes the processor to initiate transmission of power signals, and/or to receive and/or transmit communication signals, and/or perform other operations described herein.

Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming that causes a processor to perform the operations disclosed herein can be stored in a computer readable storage medium internal to the passive-to-active tag converter 102. A computer readable storage medium comprises volatile storage such as random access memory, non-volatile storage (e.g., FLASH storage, read-only-memory, etc.), or combinations thereof.

Some embodiments can implement portions of the passive-to-active tag converter 102, including portions of the controller 302 and the transceivers 304, 310 using dedicated circuitry (e.g., dedicated circuitry implemented in an integrated circuit). Some embodiments may use a combination of dedicated circuitry and a processor executing suitable software. For example, some portions of the transceivers 304, 310 may be implemented using a processor or hardware circuitry. Selection of a hardware or processor/software implementation of embodiments is a design choice based on a variety of factors, such as cost, time to implement, and the ability to incorporate changed or additional functionality in the future.

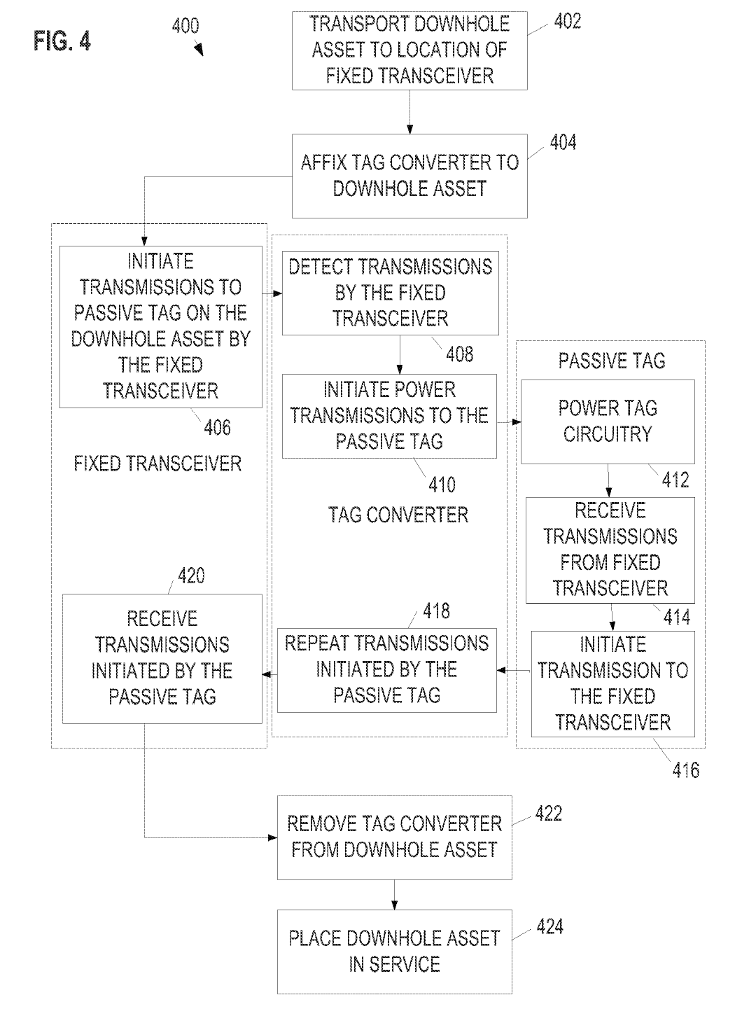

FIG. 4 shows a flow diagram for a method for communicating with the downhole asset 104 including the passive wireless tag 102 in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 4, as well as other operations described herein, can be implemented as instructions stored in a computer readable medium and executed by one or more processors.

In block 402, the downhole asset 104 is transported to a facility or site where the fixed wireless transceiver 106 is located and used to communicate with the wireless tags that are associated with downhole assets. For example, the downhole asset 104 may be transported from a drilling rig, where the downhole asset 104 was deployed for use, to a storage and/or reconditioning facility where the downhole asset 104 is prepared for future deployment on a drilling rig. The fixed wireless transceiver 106 communicates with the passive wireless tag 102 attached to the downhole asset 104 when the downhole asset 104 is within communication range, determines the identity of the downhole asset 104 from information provided by the passive wireless tag 102, and provides the identity information to an asset management system.

In block 404, because the communication range of the passive wireless tag 102 may be no more than a few inches, the passive-to-active tag converter 108 is affixed to the downhole asset 104 when the downhole asset 104 arrives at the site where the fixed wireless transceiver 106 is located. The passive-to-active tag converter 108 wirelessly provides power to the passive wireless tag 102, allowing the passive wireless tag to communicate over a range similar to that of an active wireless tag. Without the passive-to-active tag converter 108, the passive wireless tag 102 would need to be located within inches of the fixed wireless transceiver 106 to enable communication, or a mobile wireless transceiver would need to be employed in place of the fixed wireless transceiver 106.

To attach the passive-to-active tag converter 108 to the downhole asset 104, the retention members 202 of the passive-to-active tag converter 108 may be suitably manipulated. For example, bistable retention members may be manipulated to assume a cylindrical shape that wraps about the cylindrical outer surface of the downhole asset 104. As the passive-to-active tag converter 108 is attached to the downhole asset 104, the communication module 204 may be aligned with the passive wireless tag 102 to provide optimum wireless transfer of power from the power antenna 306 of the passive-to-active tag converter 108 to the passive wireless tag 102.

In block 406, the fixed wireless transceiver 104 initiates wireless transmission for communication with the passive wireless tag 104 attached to the downhole asset 104. The wireless transmissions may be long wave magnetic signal transmissions in accordance with the IEEE 1902.1 standard.

In block 408, the passive-to-active tag converter 108 detects the wireless transmissions produced by the fixed wireless transceiver 106. Based on the detection of the transmissions, in block 410, the passive-to-active tag converter 108 initiates wireless power transmission to the passive wireless tag 102. The wireless power transmission may be inductive, and use a different frequency band than the wireless transmissions produced by the fixed wireless transceiver 106. In some embodiments, the passive-to-active tag converter 108 may retransmit (i.e., repeat) at least some of the wireless transmissions produced by the fixed wireless transceiver 104.

In block 412, the passive wireless tag 102 receives the power transmissions provided by the passive-to-active tag converter 108, and powers the circuitry of the passive wireless tag 102, using power derived from the received power transmissions. The powered circuitry may include a communication signal transceiver configured to receive the wireless communication signals produced by the fixed wireless transceiver 106, and to transmit information to the fixed wireless transceiver.

In block 414, passive wireless tag 102 receives the communication transmissions originating at the fixed wireless transceiver 106. In response to the received communication transmissions, the passive wireless tag 102 initiates transmission of wireless signals to the fixed wireless transceiver 106 in block 416. The transmissions may include information identifying the downhole asset 104 to which the wireless passive tag 102 is attached.

In block 418, the passive-to-active tag converter 108 receives the wireless transmissions produced by the passive wireless tag 102 and retransmits (i.e., repeats) the information contained in the received transmissions. By repeating the transmissions, the passive-to-active tag converter 108 may provide an increased communication range to the passive wireless tag 102. In some embodiments, the passive wireless tag 102 may communicate directly with the fixed wireless transceiver 106, rather than the passive-to-active tag converter 108 repeating the transmissions of the passive wireless tag 102.

In block 420, the fixed wireless transceiver 106 receives the wireless transmissions initiated by passive wireless tag 102. The received signals may be received directly from the passive wireless tag 102, or may be repeated by the passive-to-active tag converter 108. The fixed wireless transceiver 106 extracts information, including downhole asset identification information, from the received signals, and may provide the information to an asset management system that tracks equipment located at the site.

In block 422, the downhole asset 104 is being prepared to leave the facility where the fixed wireless transceiver 104 is located. For example, the downhole asset 104 may be prepared for deployment on a drilling rig. The passive-to-active tag converter 108 is removed from the downhole asset 104 in preparation for relocation of the downhole asset 104 from the site.

In block 424, the downhole asset 104 is deployed for service. Alternatively, if the service life of the downhole asset 104 has expired, then the downhole asset 104 may be scrapped.

The above discussion is meant to be illustrative of various embodiments of the present invention. Numerous variations and modifications will become apparent to those skilled in the art once the above disclosure is fully appreciated. It is intended that the following claims be interpreted to embrace all such variations and modifications.

What is claimed is:

1. A device for powering a passive wireless tag, comprising:
a power source;
a first antenna; and
a controller;
wherein the controller is configured to:
detect a wireless signal transmission directed to the passive wireless tag by a remote transmitter; and
transmit power extracted from the power source, via the first antenna, to the passive wireless tag, responsive to detection of the wireless signal transmission, the transmitted power to be used to power the passive wireless tag.

2. The device of claim 1, wherein the controller is configured to:
receive wireless signals transmitted by the passive wireless tag, and wirelessly retransmit the data encoded in the received wireless signals.

3. The device of claim 1, further comprising:
an enclosure encompassing the power source, the first antenna, and the controller; and
a retention member coupled to the enclosure, the retention member configured to engage a structure comprising the passive wireless tag, and to attach the device to the structure.

4. The device of claim 3, wherein the retention member comprises a bistable element configured to wrap about the structure comprising the passive tag.

5. The device of claim 3, wherein the enclosure comprises an alignment feature configured to align the first antenna with the passive wireless tag when the device is installed on the structure comprising the passive tag.

6. The device of claim 1, further comprising a second antenna coupled to the controller, the second antenna configured to receive the wireless signal, wherein the wireless signal is generated by a wireless device attempting to communicate with the passive wireless tag.

7. The device of claim 1, wherein the first antenna is configured to inductively transmit power to the passive tag.

8. The device of claim 1, wherein the device is configured to increase the communication range of the passive tag by at least a factor of ten over the communication range of the passive tag without the device.

9. The device of claim 1, wherein the wireless signal is a long wavelength magnetic signal.

10. A method for extending the communication range of a passive wireless tag, comprising:
affixing a tag converter to a tool housing the passive tag;
detecting, by the tag converter, a wireless transmission directed to the passive wireless tag; and
providing, by the tag converter, power to the passive wireless tag by wireless transmission of a power signal responsive to the detecting.

11. The method of claim 10, further comprising:
detecting, by the tag converter, wireless signals transmitted by the passive wireless tag; and
retransmitting data encoded in the wireless signals.

12. The method of claim 10, further comprising removing the tag converter from the tool prior to placing the tool into service.

13. The method of claim 10, wherein the affixing comprises attaching the tag converter to the tool at a facility comprising a transmitter at a fixed location for communicating with the passive wireless tag.

14. The method of claim 10, wherein the providing comprises inductively transferring power from the tag converter to the passive wireless tag.

15. The method of claim 10, wherein the affixing comprises aligning an antenna of the tag converter with the passive wireless tag; wherein the antenna is configured to transmit the power signal.

16. The method of claim 10, wherein the tool is a downhole tool.

17. A system for communicating with a downhole asset, comprising:
a wireless transceiver disposed at a fixed location; and
a passive-to-active tag converter configured to:
removably attach to the downhole asset;
detect wireless transmissions from the transceiver; and
wirelessly provide power to a passive wireless tag of the downhole asset responsive to detection of the wireless transmissions.

18. The system of claim 17, wherein the wireless transmissions are provided in a first frequency band, and signals wirelessly powering the tag are provided in a second frequency band.

19. The system of claim 18 wherein the passive-to-active tag converter comprises:
a first antenna tuned to the first frequency band; and
a second antenna tuned to the second frequency band.

20. The system of claim 19 wherein the passive-to-active tag converter comprises:
a controller configured to initiate generation of signals that wirelessly power the passive wireless tag; and
a battery that provides the power to wirelessly power the passive wireless tag.

21. The system of claim 20 wherein the passive-to-active tag converter comprises a bistable structure configured to affix the passive-to-active tag converter to the downhole asset.
